(19) United States
(12) Patent Application Publication
(10) Pub. No.: US 2013/0017324 A1
(43) Pub. Date: Jan. 17, 2013

(54) MANUFACTURING METHOD OF ARTIFICIAL NAIL WITH 3-DIMENSION ORNAMENT

(71) Applicant: Sung Yong Chang, Roslyn Heights, NY (US)

(72) Inventor: Sung Yong Chang, Roslyn Heights, NY (US)

(21) Appl. No.: 13/314,236

(22) Filed: Dec. 8, 2011

(30) Foreign Application Priority Data
Jul. 11, 2011 (KR) 10-2011-0068362
Oct. 13, 2011 (KR) 10-2011-0104588

(51) Int. Cl. B05D 3/12; B44C 1/18

(52) U.S. Cl. 427/158; 427/290

(57) ABSTRACT

Provided is a manufacturing method of an artificial nail with a 3-dimensional ornament. The method includes: forming a design including a 3-dimensional ornament and a pattern on a base substrate; adsorbing the base substrate to a vacuum forming mold with a plurality of nail shapes; and cutting the adsorbed base substrate into the shapes of the artificial nails thereby forming bodies of the artificial nails, wherein forming the design includes printing the pattern on the base substrate providing the transparent 3-dimensional ornament so that light is transmitted by the shape of the pattern at a position where the pattern is formed. Thus, an artificial nail with a 3-dimensional ornament can be provided at low costs, and ornaments of various and more delicate designs can be printed on the surface of the artificial nail.

### CROSS-REFERENCE TO RELATED APPLICATIONS

This application claims priority under 35 U.S.C. §119 to Korean Patent Applications Nos. 10-2011-0068362 and 10-2011-0104588 filed on Jul. 11, 2011 and Oct. 13, 2011, respectively, in the Korean Intellectual Property Office, the disclosure of which is incorporated herein by reference in its entirety.

### TECHNICAL FIELD

The following disclosure relates to a manufacturing method of an artificial nail with a 3-dimensional ornament, and in particular, to a manufacturing method of an artificial nail with a 3-dimensional ornament, in which a 3-dimensional ornament can be formed on a body formed into a curved surface without shape deformation.

### BACKGROUND

In general, artificial nails are manufactured by injection molding. As shown in FIGS. 1(a) and 1(b), when artificial nails are manufactured by injection molding, molded bodies are separated from an injection stem for use after the injection molding. That is, materials of artificial nails 2 are injected into an injection machine having incised and raised injection molds which form a pair so as to be molded into nail shapes, and the artificial nails 2 molded by the injection machine are in a state of being attached to an injection stem 1. The artificial nails 2 molded in the state of being attached to the injection stem 1 are decorated with predetermined colors or shapes by a curved surface printing or spray printing method. When 3-dimensional ornaments are to be attached thereto, as shown in FIG. 1(b), a 3-dimensional ornament 3 is held with tweezers P and is directly attached to the artificial nail 2. Therefore, accuracy at which the 3-dimensional ornament 3 can be attached to a desired position varies every time according to proficiency. Even though the 3-dimensional ornament 2 is attached to the artificial nail using a machine or the like, since the artificial nail 2 is formed into a curved surface, there is a problem in that when the 3-dimensional ornament 3 is attached to the artificial nail 2 by exerting a vertical force, the shape of the artificial nail 2 is deformed.

In addition, in a manufacturing method of an artificial nail according to related art, since artificial nails are manufactured by injection molding, a production output of artificial nails that can be produced at a time is low due to a limit of the number of cavities of injection molds. Furthermore, in a process of detaching the artificial nail 2 from the injection stem 1, when a part of the injection stem 1 remains in the artificial nail, the surface of the artificial nail 2 has to be trimmed individually by a user before applying the artificial nail 2 to the nail. In this process, the deformation of the artificial nail 2 may also occur. In addition, when artificial nails are manufactured by the injection molding, there is a problem in that an ABS resin has to be used and it is difficult to manufacture artificial nails of other materials.

Therefore, there has been a need for developing a manufacturing method of an artificial nail with a 3-dimensional ornament, capable of easily applying a design including a luminant 3-dimensional ornamental as well as a general 3-dimensional ornament into uniform shapes, preventing the generation of deformation of the body shape of an artificial nail formed into a curved shape, and enhancing a production output of artificial nails.

### SUMMARY

An embodiment of the present disclosure is directed to providing a manufacturing method of an artificial nail with a 3-dimensional ornament, capable of easily applying a design including a luminant 3-dimensional ornamental as well as a general 3-dimensional ornament into uniform shapes, and at the same time, enhancing a production output of the artificial nails while preventing deformation of the shapes of the bodies of the artificial nails formed into curved surfaces.

In one general aspect, there is provided a manufacturing method of an artificial nail with a 3-dimensional ornament, including: a design operation of forming a design including a 3-dimensional ornament and a pattern on a base substrate; a body forming operation of adsorbing the base substrate to a vacuum forming mold with a plurality of nail shapes; and a cutting operation of cutting the adsorbed base substrate into the shapes of the artificial nails thereby forming bodies of the artificial nails, wherein the design operation includes a planographic printing operation of printing the pattern on the base substrate; and a 3-dimensional ornament forming operation of providing the transparent 3-dimensional ornament so that light is transmitted by the shape of the pattern at a position where the pattern is formed.

In the 3-dimensional ornament forming operation, a 3-dimensional layer having a convex shape to give a 3-dimensional effect to the pattern, and a coating paint layer formed between 3-dimensional layer and the pattern to cause the 3-dimensional layer to be adhered to the pattern may be formed.

The pattern may include a luminant reflective layer.

The reflective layer may be formed of a metallic ink.

The reflective layer may be formed of one of a metal thin film and a metal powder.

A reflective material fixing layer may further be formed between the reflective layer and the base substrate.

The 3-dimensional layer may be formed by a silkscreen technique.

The coating paint layer may be formed of one or more selected from a UV resin, a urethane resin, an acrylic resin, a cellulose resin, a polyester resin, a vinyl resin, a polyamide resin, an epoxy resin, an alkyd resin, and a martex casein.

The 3-dimensional layer may be formed of one of an epoxy resin, a silicone resin, an epoxy-silicone resin blend, an acrylic resin, a urethane resin, and an acrylic-urethane resin blend.

The 3-dimensional layer may further include one or more of a dye capable of transmitting light to reach the pattern, and a luminant glitter.

The 3-dimensional layer may be convexly formed to have a curvature so as to cause the pattern to collect light.

A contact angle of the 3-dimensional layer having the curvature may be 20° to 70°.

An adhesive layer and a release sheet protecting the adhesive layer may further be formed on a lower surface of the body of the artificial nail.

The base substrate may be formed of a blend or a copolymer of one or more of PVC, polyurethane, PVDC, EVA, PP, and PETG.

In the body forming operation, the base substrate may be inserted into the vacuum forming mold after being heated.

A cooling operation of cooling the absorbed base substrate may further be included between the body forming operation and the cutting operation.

Other features and aspects will be apparent from the following detailed description, the drawings, and the claims.

### BRIEF DESCRIPTION OF THE DRAWINGS

The above and other objects, features and advantages of the present disclosure will become apparent from the following description of certain exemplary embodiments given in conjunction with the accompanying drawings, in which:

FIGS. 1(a) and 1(b) are respectively a top view and a front view of a general artificial nail.

FIG. 2 is a flowchart of a manufacturing method of an artificial nail with a 3-dimensional ornament according to an embodiment of the disclosure.

FIGS. 3(a) to 3(d) are schematic diagrams of the manufacturing method of an artificial nail with a 3-dimensional ornament according to an embodiment of the disclosure.

FIGS. 4(a) to 4(c) are cross-sectional views of artificial nails manufactured by the manufacturing method of an artificial nail with a 3-dimensional ornament according to various embodiments of the disclosure.

### DETAILED DESCRIPTION OF EMBODIMENTS

The advantages, features and aspects of the present disclosure will become apparent from the following description of the embodiments with reference to the accompanying drawings, which is set forth hereinafter. The present disclosure may, however, be embodied in different forms and should not be construed as limited to the embodiments set forth herein. Rather, these embodiments are provided so that this disclosure will be thorough and complete, and will fully convey the scope of the present disclosure to those skilled in the art. The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

In order to provide a glittering effect to a part of a nail, in general, a 3-dimensional ornament such as a jewel is directly attached to the nail by hand. Unlike a method according to related art, an artificial nail 100 with a 3-dimensional ornament 120 according to the disclosure is formed by forming a reflective layer 112′ of a glittering material to be included in the pattern 112, and convexly covering the upper surface of the reflective layer 112′ with a transparent material, in a process of forming a pattern 112. Since the 3-dimensional ornament 120 formed by such a method has a volume sensation and luminant properties, the 3-dimensional ornament 120 realizes the form of a jewel having glittering properties by the reflective layer 112′. That is, according to the disclosure, the 3-dimensional ornament 120 formed on the artificial nail 100 is formed through a printing technique, and thus the shape, the size, and the formation position of the 3-dimensional ornament 120 can be controlled. Therefore, unlike a 3-dimensional ornament 120 attached by hand, a 3-dimensional ornament 120 with a uniform design can be provided in the artificial nail 100, and a process of heating an adhesive of the 3-dimensional ornament 120 can be omitted from a process of attaching the 3-dimensional ornament 120 as in the related art, so that generation of thermal deformation of a local site of a base substrate 10 can be prevented. In addition, a time taken for a manufacturing process of the artificial nail 100 with the 3-dimensional ornament 120 can be reduced, and since the base substrate 10 itself has a flat plate shape, in a process of forming a design, the design can be drawn by 2-dimensional programming unlike the related art, and thus accuracy of a process performed in a design operation S10 can be enhanced.

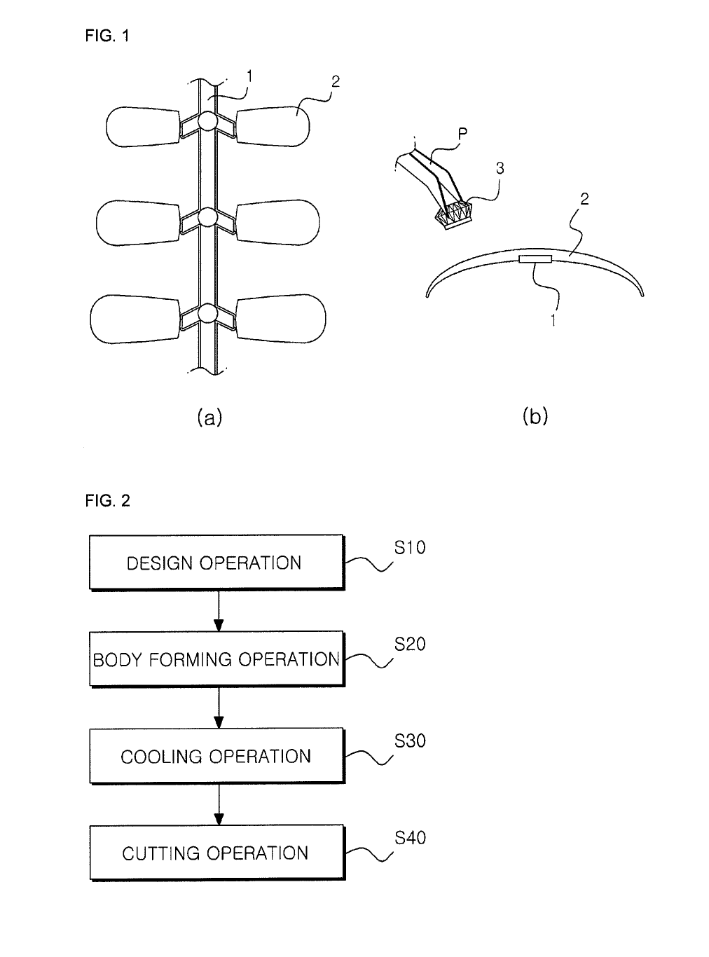

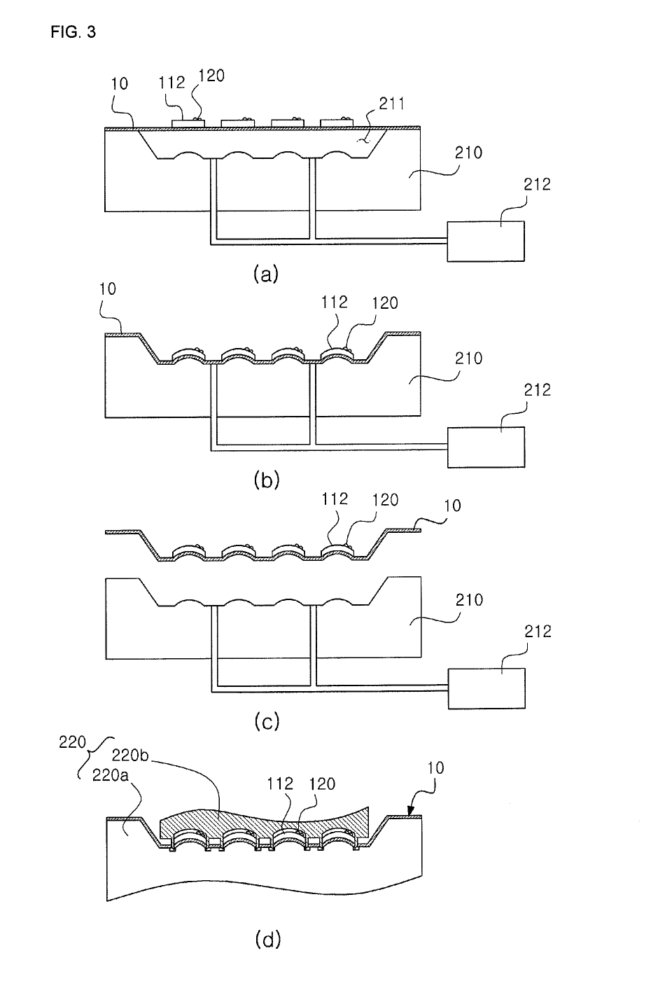

FIG. 2 shows a flowchart of the manufacturing method of an artificial nail with a 3-dimensional ornament according to an embodiment of the disclosure, and FIGS. 3(a) to 3(d) show schematic diagrams of the manufacturing method of an artificial nail with a 3-dimensional ornament according to an embodiment of the disclosure.

The manufacturing method of an artificial nail with a 3-dimensional ornament according to the disclosure includes: as shown in FIGS. 2 to 3(d), the design operation S10 of forming a design including the 3-dimensional ornament 120, the pattern 112, and the reflective layer 112′ included in the pattern 112 on the base substrate 10; a body forming operation S20 of adsorbing the base substrate 10 to a vacuum forming mold 210 with a plurality of nail shapes; and a cutting operation S40 of cutting the adsorbed base substrate 10 into the shapes of the artificial nails 100 thereby forming bodies 110 of the artificial nails 100, wherein the design operation S10 includes: a planographic printing operation of printing the pattern 112 on the base substrate 10; and a 3-dimensional ornament 120 forming operation of providing the transparent 3-dimensional ornament 120 so that light is transmitted by the shape of the pattern 112 at a position where the pattern 112 is formed.

The design operation S10 is, as shown in FIG. 3(a), an operation of forming the design on the base substrate 10 supplied to the vacuum forming mold 210. The design formed on the base substrate 10 may be a flat plate type pattern 112 or may be a 3-dimensional ornament 120 at the same time with the flat plate-type pattern 112. The pattern 112 may be provided only at a position where the 3-dimensional ornament 120 is formed or may be provided at other regions.

When the base substrate 10 that is subjected to the design operation S10 is supplied to the vacuum forming mold 210, a space 211 is formed between the flat plate-shaped base substrate 10 and the vacuum forming mold 210. When the air in the space 211 is sucked by a vacuum pump 212, as shown in FIG. 3(b), the base substrate 10 undergoes shape deformation according to the shape of the vacuum forming mold 210. Here, the heated base substrate 10 may be supplied to the vacuum forming mold 210 so that the base substrate 10 undergoes shape deformation more properly according to the shape of the vacuum forming mold 210. The temperature at which the base substrate 10 is heated may be changed according to the material used for the base substrate 10. In the manufacturing method of an artificial nail with a 3-dimensional ornament according to this disclosure, unlike the method of manufacturing an artificial nail 100 by an injection molding method, the shape of the base substrate 10 can be freely formed by a vacuum method as long as the base substrate 10 can be formed into a flat plate shape, so that various materials can be used for manufacturing the artificial nail 100. The materials that can be used for the base substrate 10 include PVC, polyurethane, PVDC, EVA, PP, and PETG, and the materials may be used as simple materials, or a blend of one or more kinds thereof or a copolymer thereof may be used as the material of the base substrate 10.

When the base substrate 10 heated in the body forming operation S20 is supplied, a cooling operation S30 of cooling the formed base substrate 10 may further be included. The cooling operation S30 may be performed when the base substrate 10 is stably placed on the vacuum forming mold 210 or as shown in FIG. 3(c), after the base substrate 10 is detached from the vacuum forming mold 210. The formed base substrate 10 is, as shown in FIG. 3(d), cut out by a cutting device 220 into the shapes of individual artificial nails 100. The cutting device 220 may be divided into a lower cutting device 220a on which the base substrate 10 is stably placed, and an upper cutting device 220b with blades and causes the 3-dimensional ornament 120 not to be excessively pressurized by the upper cutting device 220b. For this, when the upper cutting device 220b and the lower cutting device 220a are combined with each other, the interval between the upper cutting device 220b and the lower cutting device 220a inside the blades for cutting a single artificial nail 100 may be controlled to be greater than the thickness of the artificial nail 100.

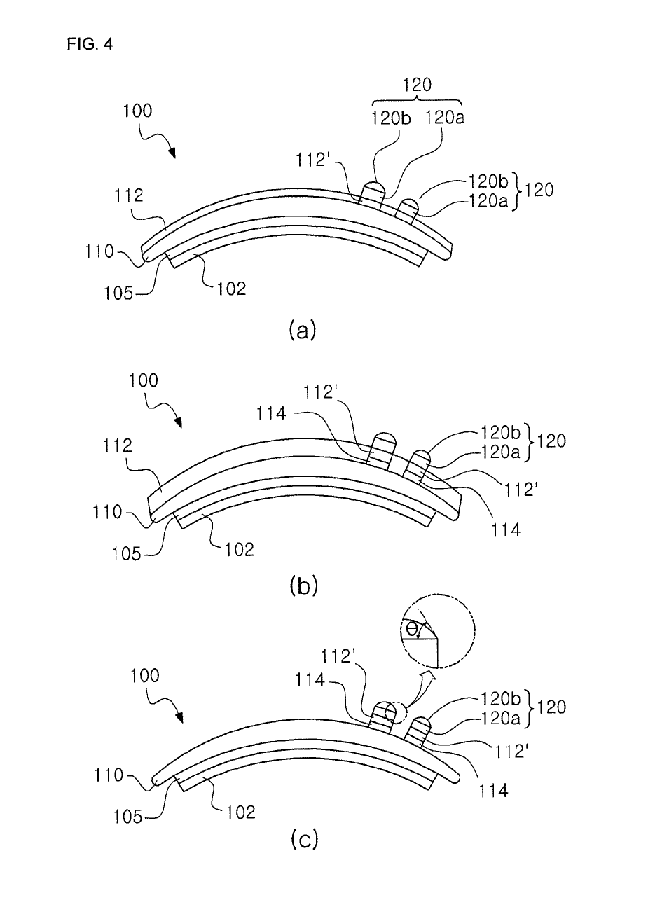

FIGS. 4(a) to 4(c) show cross-sectional views of artificial nails manufactured by manufacturing methods of an artificial nail with a 3-dimensional ornament according to various embodiments of the disclosure.

In the manufacturing method of an artificial nail with a 3-dimensional ornament according to the disclosure, by forming a 3-dimensional ornament 120 having, particularly, luminosity of reflecting light as the 3-dimensional ornament 120, the effect of attaching jewelry to the artificial nail 100 can be obtained, and at the same time, a time taken to form the 3-dimensional ornament 120 on the artificial nail 100 can be reduced.

In the operation of forming the 3-dimensional ornament 120, in order to form a 3-dimensional layer 120b having a convex shape to give a 3-dimensional effect to the reflective layer 112′ and attach the 3-dimensional layer 120b to the reflective layer 112′, a coating paint layer 120a is formed between the 3-dimensional layer 120b and the reflective layer 112′. As the coating paint layer 120a is provided between the reflective layer 112′ and the 3-dimensional layer 120b, the 3-dimensional layer 120b can be stably placed on the upper surface of the reflective layer 112′. To form the 3-dimensional layer 120b, an epoxy resin, a silicone resin, an acrylic resin, a urethane resin, an epoxy-silicone resin blend, and an acrylic-urethane resin blend may be used. As such, the adhesion of the material used for forming the 3-dimensional layer 120b to the reflective layer 112′ is weak, so that the reflective layer 112′ and the 3-dimensional layer 120b are separated from each other by weak scratches. Therefore, by providing the coating paint layer 120a between the reflective layer 112′ and the 3-dimensional layer 120b, the 3-dimensional layer 120b can be stably placed on the upper surface of the reflective layer 112′. Here, the coating paint layer 120a may be formed of one or more selected from a UV resin, a urethane resin, an acrylic resin, a cellulose resin, a polyester resin, a vinyl resin, a polyamide resin, an epoxy resin, an alkyd resin, and a martex casein.

Since the coating paint layer 120a and the 3-dimensional layer 120b are formed of transparent materials that all can transmit light, the reflective layer 112′ can exhibit the luminosity performance as the light is transmitted by the reflective layer 112′. As dyes, glitters, and the like are contained in the 3-dimensional layer 120b, the color of light reflected from the reflective layer 112′ and a degree of reflection of the light can be controlled. In regard to the reflective layer 112′, a layer contained in the pattern 112 and designed with a luminant material is particularly referred to as a reflective layer 112′. That is, the pattern 112 that exhibits the luminosity performance by the light transmitted through the 3-dimensional layer 120b while a volume sensation is given by the 3-dimensional layer 120b is referred to as the reflective layer 112′. According to the disclosure, other designs than the reflective layer 112′ may also be contained in the pattern 112. However, only a case where the 3-dimensional ornament 120 is formed on the upper portion of the reflective layer 112′ is described.

In regard to the reflective layer 112′, as the material capable of exhibiting luminosity performance, a metallic ink may be applied to the base substrate 10 to form the reflective layer 112′ on the body 110. Otherwise, a metal thin film, a metal powder, or the like may be formed on the base substrate 10 to form the reflective layer 112′ on the body 110. So as to form the metal thin film or the metal powder on the base substrate 10, a reflective material fixing layer 114 may further be formed between the reflective layer 112′ and the base substrate 10.

Any forming method may be used as long as the 3-dimensional layer 120b can be formed into a convex shape. However, the 3-dimensional layer 120b may be formed by a silkscreen technique so as to cause the shape of the 3-dimensional layer 120b to be convexly formed particularly into a water drop form. The silkscreen technique may be used for forming the 3-dimensional layer 120b at a position where the luminant 3-dimensional ornament 120 such as a jewel is to be formed.

That is, due to the characteristics of the 3-dimensional layer 120b that can be applied to only a position provided with the coating paint layer 120a, the position where the 3-dimensional layer 120b is formed may be changed depending on the position where the coating paint layer 120a is formed. For example, when the coating paint layer 120a is provided only at a position where the reflective layer 112′ is formed, the 3-dimensional layer 120b applied only to the upper portion of the coating paint layer 120a is formed. In addition, although the coating paint layer 120a is formed over the entire base substrate layer, when the position to be expressed by the 3-dimensional ornament 120 is limited to a partial position of the base substrate, the 3-dimensional layer 120b may be formed by a silkscreen technique to form the thickness of the 3-dimensional layer 120b and the pattern 112 according to the pattern 112 of the reflective layer 112′. That is, in order to provide the effect of the 3-dimensional ornament 120, an epoxy resin is repeatedly applied to a particular position by a silkscreen printing method, thereby forming the 3-dimensional layer 120b. When the 3-dimensional layer 120b is convexly formed into a water drop form, the 3-dimensional layer 120b transmitting light has light collecting properties like a convex lens, so that luminosity of the reflective layer 112′ is enhanced as a larger amount of light is collected by luminant materials provided in the reflective layer 112′. Moreover, the design of the reflective layer 112′ is expanded, so that the appearance of the 3-dimensional ornament is enhanced.

In this disclosure, a contact angle θ of the 3-dimensional layer 120b is referred to as an angle between the tangent of the 3-dimensional layer 120b at the lower end point where the 3-dimensional layer 120b and the coating paint layer 120a come into contact with each other and the bottom surface of the 3-dimensional layer 120b, and this angle is measured on the inside of the 3-dimensional layer 120b. The contact angle θ of the 3-dimensional layer 120b may be formed to be 20° to 70°. When the contact angle θ of the 3-dimensional layer 120b exceeds 70°, the upper surface of the 3-dimensional layer 120b becomes excessively convex and thus a light collecting site is limited to a partial portion. In addition, when the contact angle θ of the 3-dimensional layer 120b is formed to be smaller than 20°, the upper surface of the 3-dimensional layer 120 is flat, and thus the light collecting properties are significantly degraded, so that the luminosity of the reflective layer 112′ cannot be enhanced. Therefore, the contact angle θ of the 3-dimensional layer 120b may be 20° to 70°.

When the artificial nails 100 are manufactured according to the shape properties as described above, in the manufacturing method of an artificial nail with a 3-dimensional ornament according to the disclosure, the artificial nails 100 can be manufactured according to various embodiments as shown in FIGS. 4(a) to 4(c). That is, as shown in FIG. 4(a), the pattern 112 is formed on the upper portion of the body 110 of the artificial nail 100, and the pattern 112 is formed while including the reflective layer 112′, so that the 3-dimensional ornament 120 including the coating paint layer 120a and the 3-dimensional layer 120b on the upper portion of the reflective layer 112′ is provided. In addition, when the reflective layer 112′ is formed on the body 110 by forming the reflective material fixing layer 114, first, as shown in FIG. 4(b), the pattern 112 including the reflective layer 112′ formed on the body 110 by the reflective material fixing layer 114 may be formed on the body 110. The 3-dimensional ornament 120 is positioned on the upper portion of the reflective layer 112′ in the pattern 112. In addition, when only the reflective layer 112′ is formed on the body 110 as the pattern 112, as shown in FIG. 4(c), the 3-dimensional ornament 120 may be provided only at a position where the reflective layer 112′ is formed. Here, the reflective layer 112′ is illustrated to be joined to the body 110 by the reflective layer fixing layer 114. However, like the case where the metallic ink is used, the reflective layer 112′ may be directly applied to the upper portion of the body 110 without the reflective layer fixing layer 114, and the 3-dimensional ornament 120 may be formed on the upper portion thereof. An additional adhesive may not be provided on the lower portion of the body 110, or as shown in FIGS. 4(a) to 4(c), an adhesive layer 105 may be formed by applying an additional adhesive onto the lower portion of the body 110 and simultaneously, a release sheet 102 for protecting the adhesive layer 105 may further be provided.

According to the disclosure, a 3-dimensional ornament having the same effect as attaching a jewel can be provided at a constant position by applying a 3-dimensional layer to the upper portion of a reflective layer to be convex, and the size and the position of the 3-dimensional ornament can be easily controlled since the 3-dimensional ornament is provided using a printing technique, so that a time taken to perform a manufacturing process is reduced, and costs for manufacturing are reduced. Therefore, an artificial nail with the 3-dimensional ornament can be provided at low costs, and even when unskilled persons are to enhance the appearance of the nails, they can easily select a design and apply the design to the nails, thereby improving convenience. Moreover, by a vacuum forming method, according to desired characteristics, various types of materials can be selected for the body of the artificial nail, and a production amount of artificial nails that can be produced at the same manufacturing costs as those used to form the artificial nails by an injection molding method is enhanced. In addition, since the 3-dimensional ornament is formed on the base substrate before the body forming operation, more delicate designs can be formed on the surfaces of the artificial nails.

While the present disclosure has been described with respect to the specific embodiments, it will be apparent to those skilled in the art that various changes and modifications may be made without departing from the spirit and scope of the disclosure as defined in the following claims.

What is claimed is:

1. A manufacturing method of an artificial nail with a 3-dimensional ornament, comprising:
a design operation of forming a design including a 3-dimensional ornament and a pattern on a base substrate;
a body forming operation of adsorbing the base substrate to a vacuum forming mold with a plurality of nail shapes; and
a cutting operation of cutting the adsorbed base substrate into the shapes of the artificial nails thereby forming bodies of the artificial nails,
wherein the design operation includes a planographic printing operation of printing the pattern on the base substrate; and a 3-dimensional ornament forming operation of providing the transparent 3-dimensional ornament so that light is transmitted by the shape of the pattern at a position where the pattern is formed.

2. The manufacturing method according to claim 1, wherein, in the 3-dimensional ornament forming operation, a 3-dimensional layer having a convex shape to give a 3-dimensional effect to the pattern, and a coating paint layer formed between 3-dimensional layer and the pattern to cause the 3-dimensional layer to be adhered to the pattern are formed.

3. The manufacturing method according to claim 1, wherein the pattern includes a luminant reflective layer.

4. The manufacturing method according to claim 3, wherein the reflective layer is formed of a metallic ink.

5. The manufacturing method according to claim 3, wherein the reflective layer is formed of one of a metal thin film and a metal powder.

6. The manufacturing method according to claim 5, wherein a reflective material fixing layer is further formed between the reflective layer and the base substrate.

7. The manufacturing method according to claim 2, wherein the 3-dimensional layer is formed by a silkscreen technique.

8. The manufacturing method according to claim 2, wherein the coating paint layer is formed of one or more selected from a UV resin, a urethane resin, an acrylic resin, a cellulose resin, a polyester resin, a vinyl resin, a polyamide resin, an epoxy resin, an alkyd resin, and a martex casein.

9. The manufacturing method according to claim 2, wherein the 3-dimensional layer is formed of one of an epoxy resin, a silicone resin, an epoxy-silicone resin blend, an acrylic resin, an urethane resin, and an acrylic-urethane resin blend.

10. The manufacturing method according to claim 2, wherein the 3-dimensional layer further includes one or more of a dye capable of transmitting light to reach the pattern, and a luminant glitter.

11. The manufacturing method according to claim 2, wherein the 3-dimensional layer is convexly formed to have a curvature so as to cause the pattern to collect light.

12. The manufacturing method according to claim 11, wherein a contact angle of the 3-dimensional layer having the curvature is 20° to 70°.

13. The manufacturing method according to claim 1, wherein an adhesive layer and a release sheet protecting the adhesive layer are further formed on a lower surface of the body of the artificial nail.

14. The manufacturing method according to claim 1, wherein the base substrate is formed of a blend or a copolymer of one or more of PVC, polyurethane, PVDC, EVA, PP, and PETG.

15. The manufacturing method according to claim 1, wherein, in the body forming operation, the base substrate is inserted into the vacuum forming mold after being heated.

16. The manufacturing method according to claim 15, further comprising a cooling operation of cooling the adsorbed base substrate between the body forming operation and the cutting operation.
